(19) United States
(12) Patent Application Publication
(10) Pub. No.: US 2026/0115088 A1
(43) Pub. Date: Apr. 30, 2026

(54) Structure of adjusting massage contact surface strength of massage chair

(71) Applicant: Shanghai Rongtai Health Technology Corporation Limited, Shanghai (CN)

(72) Inventor: Dong-Her Wu, Chang Hua Hsien (TW)

(21) Appl. No.: 19/185,865

(22) Filed: Apr. 22, 2025

(30) Foreign Application Priority Data
Oct. 28, 2024 (TW) 113141257

(51) Int. Cl. A61H 15/00

(52) U.S. Cl. CPC A61H 15/0078; A61H 2015/0035; A61H 2201/0149; A61H 2201/0192; A61H 2201/1215; A61H 2201/14; A61H 2201/1669

(57) ABSTRACT

A structure of adjusting a massage contact surface strength of a massage chair contains: a base and a massager. The base includes a frame, a rotary shaft, a first motor. The massager includes a first rotary shaft and a second rotary shaft, the first rotary shaft includes two first rotatable wheels, and a respective one first rotatable wheel has a first threaded gear. The second rotary shaft includes two second rotatable wheels, and a respective one second rotatable wheel has a second threaded gear. The massager further includes a second motor, and a drive wheel is meshed with the respective one first rotatable wheel and the respective one second rotatable wheel. Thereby, the first threaded gear is configured to roll the respective one first rope, and the second threaded gear is configured to unroll the respective one second rope.

### TECHNICAL FIELD

The present invention relates to a structure of adjusting a massage contact surface strength of a massage chair which is capable of adjusting a massaging force based on using requirements.

### BACKGROUND

Nowadays, workers generally have problems with incorrect postures and repetitive mechanical labor, which causes muscle stiffness and degeneration. Therefore, using a massage chair to massage and relax muscles can reduce the risk of injury and degeneration. When sitting on a massage chair, the massage contact surface of the massage machine is protruding, making it uncomfortable as a general sofa. This is one of the reasons why it has become decorative furniture in the long run. In addition, the massage intensity of the contact surface of the massage chair is uneven, which may cause insufficient or excessive force for different users, resulting in a significant reduction in the effectiveness of massage to relax muscles.

A conventional massage machine include a body having a long rail extending in the direction of the first end and the second end, and the rail is hollow inside to provide a drive for the massage component to be inserted into a set, so that the massage component can move along the rail. Although the massage body can protrude to continuously massage the human body, when such a massage component is installed in a massage chair, the massage chair is not suitable as a general seat due to the continuous protrusion of the massage body, and the massage force may not be suitable for any user. If the massage equipment can be hidden and the force of the massage equipment can be adjusted according to the needs, it will surely make the massage chair more practical

In addition, the massage machine relies on tension rather than fixed track movement to conform to the human body, and its movement trajectory must be stabilized to maintain the massage machine's massage and muscle relaxation effect.

The present invention has arisen to mitigate and/or obviate the afore-described disadvantages.

### SUMMARY

The primary aspect of the present invention is to provide a structure of adjusting a massage contact surface strength of a massage chair by which the drive wheel actuates the respective one first rotatable wheel and the respective one second rotatable wheel so as to roll or unroll the respective one first rope and the respective one second rope simultaneously, and the massager moves forward and backward reciprocately to massage the user. Preferably, the rotary shaft is driven by the first motor to roll or unroll the respective one rope so that the length of the middle section of the respective one second rope is adjustable to pull or retract the two ends of the massager, hence the massage contact surface strength of the massage element is adjustable or the massage element is retracted so that the user sits on the massage chair comfortably.

Another aspect of the present invention is to provide a structure of adjusting a massage contact surface strength of a massage chair by which the respective one first rope is rolled on the first threaded gear stably, and the respective one second rope is rolled on the second threaded gear stably, such that the massager moves securely to massage the user. Also, the respective one first rope and the respective one second rope are the steel cable to enhance safety coefficient and using reinforcement.

To obtain above-mentioned aspects, a structure of adjusting a massage contact surface strength of a massage chair provided by the present invention contains: a base and a massager.

The base includes a frame which has a first fringe, a second fringe, a connection fringe connected with a front end of the first fringe and a front end of the second fringe, a rotary shaft rotatably connected with a rear end of the first fringe and a rear end of the second fringe, a first motor fixed on an outer wall of the frame and configured to drive the rotary shaft to rotate. The rotary shaft has a rotation column, and the frame further includes a cap connected between the rear end of the first fringe and the rear end of the second fringe and configured to shield the rotation column, two first ropes connected on two sides of the connection fringe, and two second ropes connected on two sides of the rotation column. The two first ropes and the two second ropes are a steel cable.

The massager includes a first rotary shaft and a second rotary shaft which are rotatably connected on a front end and a rear end of the massager. The first rotary shaft includes two first rotatable wheels connected on two sides thereof, and a respective one first rotatable wheel has a first threaded gear formed thereon, and the respective one first rope is rolled on the first threaded gear of the respective one first rotatable wheel. The second rotary shaft includes two second rotatable wheels connected on two sides thereof, a respective one second rotatable wheel has a second threaded gear formed thereon, and the respective one second rope is rolled on the second threaded gear of the respective one second rotatable wheel.

The massager further includes a second motor configured to drive the first rotary shaft or the second rotary shaft to rotate, and a drive wheel is meshed with the respective one first rotatable wheel and the respective one second rotatable wheel so as to drive the respective one first rotatable wheel and the respective one second rotatable wheel to rotate in a same direction, hence the first threaded gear of the respective one first rotatable wheel is configured to roll the respective one first rope, and the second threaded gear of the respective one second rotatable wheel is configured to unroll the respective one second rope. Alternatively, the first threaded gear of the respective one first rotatable wheel is configured to unroll the respective one first rope, and the second threaded gear of the respective one second rotatable wheel is configured to roll the respective one second rope, such that the massager moves forward and backward reciprocately along an inner wall of the frame, and the massager includes a massage element configured to massage a user sit on the base.

The first motor drives the rotary shaft to rotate so that the respective one second rope is rolled on the rotation column of the rotary shaft to shorten a length of a middle section of the respective one second rope, and two ends of the massager are pulled upward so as to extend the massage element out of the base, thus massaging the user.

The first motor drives the rotary shaft to rotate so that the respective one second rope is unrolled on the rotation column of the rotary shaft to lengthen the length of the middle section of the respective one second rope, and the two ends of the massager is pulled downward so as to retract the massage element in the base, thus not massaging the user.

In another embodiment, a structure of adjusting a massage contact surface strength of a massage chair provided by the present invention contains: a base and a massager.

The frame has a first fringe, a second fringe, a connection fringe connected with a rear end of the first fringe and a rear end of the second fringe, a rotary shaft rotatably connected with a front end of the first fringe and a front end of the second fringe, a first motor fixed on an outer wall of the frame and configured to drive the rotary shaft to rotate. The rotary shaft has a rotation column, and the frame further includes a cap connected between the front end of the first fringe and the front end of the second fringe and configured to shield the rotation column, two first ropes connected on two sides of the connection fringe, and two second ropes connected on two sides of the rotation column. The two first ropes and the two second ropes are a steel cable.

The massager includes a first rotary shaft and a second rotary shaft which are rotatably connected on a front end and a rear end of the massager. The first rotary shaft includes two first rotatable wheels connected on two sides thereof, and a respective one first rotatable wheel has a first threaded gear formed thereon, the respective one second rope is rolled on the first threaded gear of the respective one first rotatable wheel. The second rotary shaft includes two second rotatable wheels connected on two sides thereof, a respective one second rotatable wheel has a second threaded gear formed thereon, and the respective one first rope is rolled on the second threaded gear of the respective one second rotatable wheel.

The massager includes a second motor configured to drive the first rotary shaft or the second rotary shaft o rotate, and a drive wheel is meshed with the respective one first rotatable wheel and the respective one second rotatable wheel so as to drive the respective one first rotatable wheel and the respective one second rotatable wheel to rotate in a same direction, hence the first threaded gear of the respective one first rotatable wheel is configured to roll the respective one second rope, and the second threaded gear of the respective one second rotatable wheel is configured to unroll the respective one first rope. Alternatively, the first threaded gear of the respective one first rotatable wheel is configured to unroll the respective one second rope, and the second threaded gear of the respective one second rotatable wheel is configured to roll the respective one first rope, such that the massager moves forward and backward reciprocately along an inner wall of the frame, and the massager includes a massage element configured to massage a user sit on the base.

The first motor drives the rotary shaft to rotate so that the respective one second rope is unrolled on the rotation column of the rotary shaft to lengthen the length of the middle section of the respective one second rope, and the two ends of the massager is pulled downward so as to retract the massage element in the base, thus not massaging the user.

### BRIEF DESCRIPTION OF THE DRAWINGS

FIG. 1 is a perspective view showing the assembly of a structure of adjusting a massage contact surface strength of a massage chair according to a preferred embodiment of the present invention.

FIG. 2 is a perspective view showing the exploded components of the structure of adjusting the massage contact surface strength of the massage chair according to the preferred embodiment of the present invention.

FIG. 3 is a side plan view showing the assembly of the structure of adjusting the massage contact surface strength of the massage chair according to the preferred embodiment of the present invention.

FIG. 4 is a cross sectional view showing the assembly of the structure of adjusting the massage contact surface strength of the massage chair according to the preferred embodiment of the present invention.

FIG. 5 is a cross sectional view showing the operation of the structure of adjusting the massage contact surface strength of the massage chair according to the preferred embodiment of the present invention.

FIG. 6 is another cross sectional view showing the operation of the structure of adjusting the massage contact surface strength of the massage chair according to the preferred embodiment of the present invention.

FIG. 7 is a perspective view showing the application of the structure of adjusting the massage contact surface strength of the massage chair according to the preferred embodiment of the present invention.

FIG. 8 is a cross sectional view showing the assembly of a structure of adjusting a massage contact surface strength of a massage chair according to another preferred embodiment of the present invention.

### DETAILED DESCRIPTION

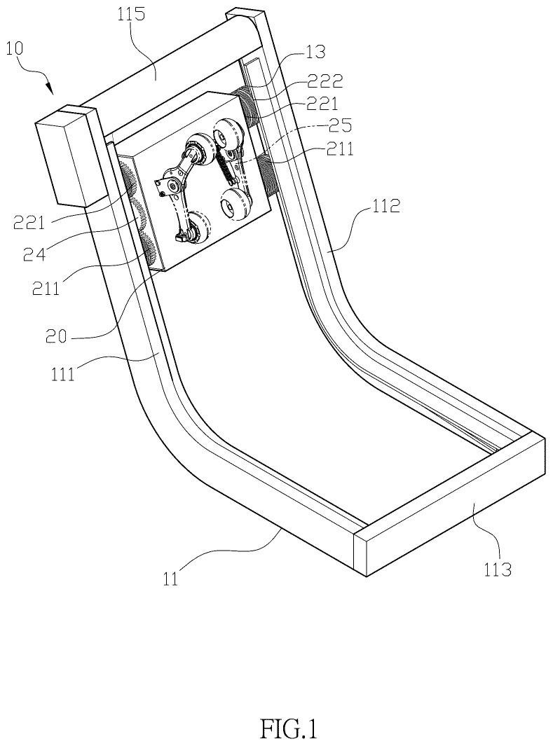

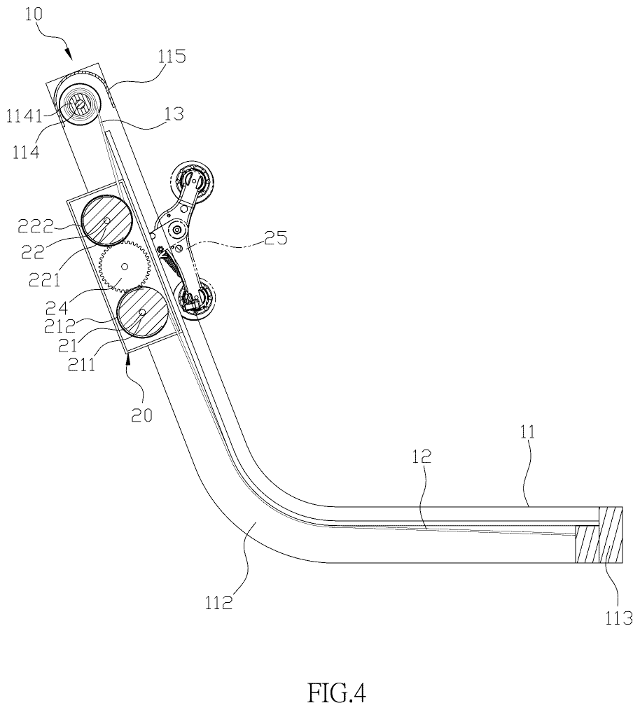

With reference to FIGS. 1-4, a structure of adjusting a massage contact surface strength of a massage chair according to a preferred embodiment of the present invention comprises: a base 10 and a massager 20, wherein the base 10 includes a frame 11 which has a first fringe 111, a second fringe 112, a connection fringe 113 connected with a front end of the first fringe 111 and a front end of the second fringe 112, a rotary shaft 114 rotatably connected with a rear end of the first fringe 111 and a rear end of the second fringe 112, a first motor 14 fixed on an outer wall of the frame 11 and configured to drive the rotary shaft 114 to rotate, wherein the rotary shaft 114 has a rotation column 1141, and the frame 11 further includes a cap 115 connected between the rear end of the first fringe 111 and the rear end of the second fringe 112 and configured to shield the rotation column 1141, two first ropes 12 connected on two sides of the connection fringe 113, and two second ropes 13 connected on two sides of the rotation column 1141, wherein the two first ropes 12 and the two second ropes 13 are a steel cable.

The massager 20 includes a first rotary shaft 21 and a second rotary shaft 22 which are rotatably connected on a front end and a rear end of the massager 20, wherein the first rotary shaft 21 includes two first rotatable wheels 211 connected on two sides thereof, and a respective one first rotatable wheel 211 has a first threaded gear 212 formed thereon, the respective one first rope 12 is rolled on the first threaded gear 212 of the respective one first rotatable wheel 211, wherein the second rotary shaft 22 includes two second rotatable wheels 221 connected on two sides thereof, a respective one second rotatable wheel 221 has a second threaded gear 222 formed thereon, and the respective one second rope 13 is rolled on the second threaded gear 222 of the respective one second rotatable wheel 221. The massager 20 includes a second motor 23 configured to drive the first rotary shaft 21 or the second rotary shaft 22 to rotate, wherein a drive wheel 24 is meshed with the respective one first rotatable wheel 211 and the respective one second rotatable wheel 221 so as to drive the respective one first rotatable wheel 211 and the respective one second rotatable wheel 221 to rotate in a same direction, hence the first threaded gear 212 of the respective one first rotatable wheel 211 is configured to roll the respective one first rope 12, and the second threaded gear 222 of the respective one second rotatable wheel 221 is configured to unroll the respective one second rope 13. Alternatively, the first threaded gear 212 of the respective one first rotatable wheel 211 is configured to unroll the respective one first rope 12, and the second threaded gear 222 of the respective one second rotatable wheel 221 is configured to roll the respective one second rope 13, such that the massager 20 moves forward and backward reciprocately along an inner wall of the frame 11, and the massager 20 includes a massage element 25 configured to massage a user sit on the base 10.

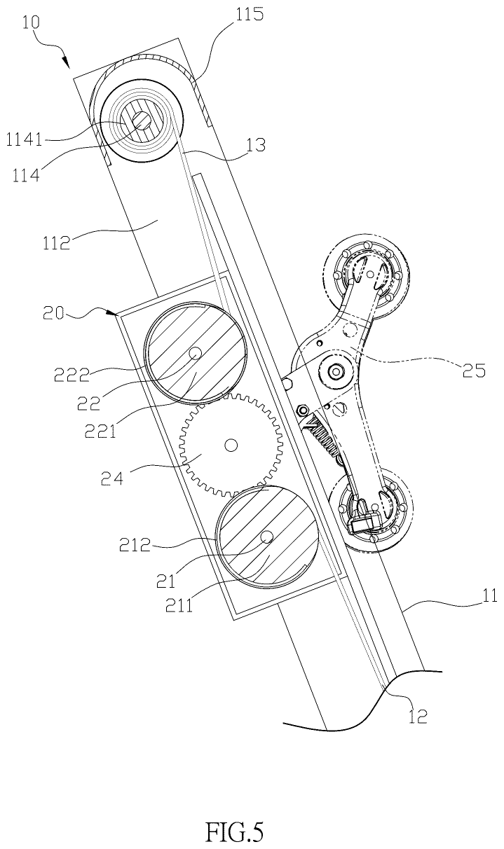

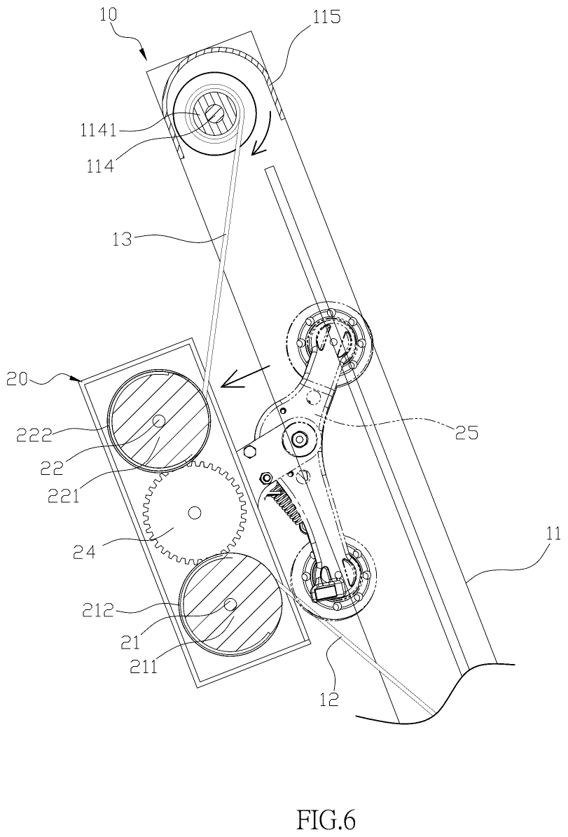

Referring to FIG. 5, in operation, the first motor 14 drives the rotary shaft 114 to rotate so that the respective one second rope 13 is rolled on the rotation column 1141 of the rotary shaft 114 to shorten a length of a middle section of the respective one second rope 13, and two ends of the massager 20 are pulled upward so as to extend the massage element 25 out of the base 10, thus massaging the user. As shown in FIG. 6, the first motor 14 drives the rotary shaft 114 to rotate so that the respective one second rope 13 is unrolled on the rotation column 1141 of the rotary shaft 114 to lengthen the length of the middle section of the respective one second rope 13, and the two ends of the massager 20 is pulled downward so as to retract the massage element 25 in the base 10, thus not massaging the user.

Thereby, the drive wheel 24 actuates the respective one first rotatable wheel 211 and the respective one second rotatable wheel 221 so as to roll or unroll the respective one first rope 12 and the respective one second rope 13 simultaneously, and the massager 20 moves forward and backward reciprocately to massage the user. Preferably, the rotary shaft 114 is driven by the first motor 14 to roll or unroll the respective one rope 13 so that the length of the middle section of the respective one second rope 13 is adjustable to pull or retract the two ends of the massager 20, hence the massage contact surface strength of the massage element 25 is adjustable or the massage element 25 is retracted so that the user sits on the massage chair comfortably.

Preferably, the respective one first rope 12 is rolled on the first threaded gear 212 stably, and the respective one second rope 13 is rolled on the second threaded gear 222 stably, such that the massager 20 moves securely to massage the user. Also, the respective one first rope 12 and the respective one second rope 13 are the steel cable to enhance safety coefficient and using reinforcement.

The massager 20 moves forward and backward reciprocately along the inner wall of the frame 11 based on a length and a using angle of the frame 11 to obtain different massaging ranges. For example, the length of the frame 11 is long enough to massage a back, buttocks, and calves of the user. Also, the massager 25 massages users with various figures by using the respective one first rope 12 and the respective one second rope 13.

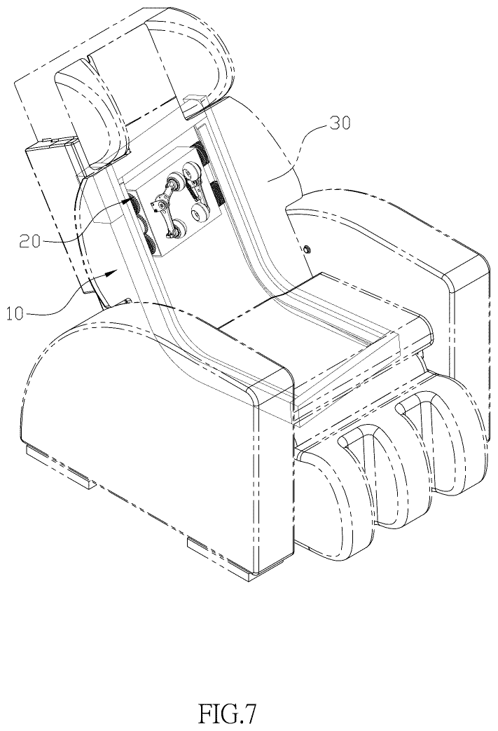

Referring to FIG. 7, in another embodiment, the base 10 and the massager 20 are mounted in the massage chair 30.

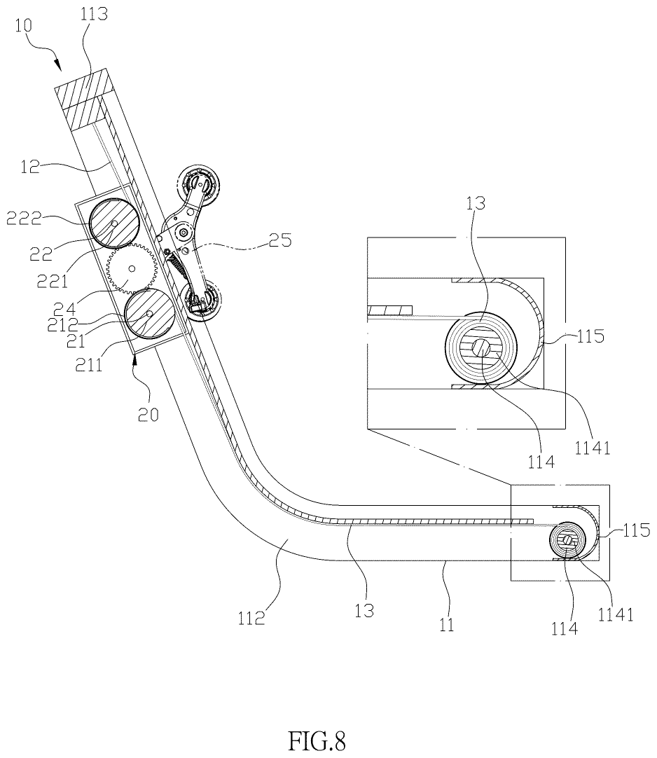

As illustrated in FIG. 8, a difference of another preferred embodiment from the preferred embodiment of the present invention comprises: the base 10 which includes a frame 11, and the frame 11 has a first fringe 111, a second fringe 112, a connection fringe 113 connected with a rear end of the first fringe 111 and a rear end of the second fringe 112, a rotary shaft 114 rotatably connected with a front end of the first fringe 111 and a front end of the second fringe 112, a first motor 14 fixed on an outer wall of the frame 11 and configured to drive the rotary shaft 114 to rotate, wherein the rotary shaft 114 has a rotation column 1141, and the frame 11 further includes a cap 115 connected between the front end of the first fringe 111 and the front end of the second fringe 112 and configured to shield the rotation column 1141, two first ropes 12 connected on two sides of the connection fringe 113, and two second ropes 13 connected on two sides of the rotation column 1141, wherein the two first ropes 12 and the two second ropes 13 are a steel cable.

The massager 20 includes a first rotary shaft 21 and a second rotary shaft 22 which are rotatably connected on a front end and a rear end of the massager 20, wherein the first rotary shaft 21 includes two first rotatable wheels 211 connected on two sides thereof, and a respective one first rotatable wheel 211 has a first threaded gear 212 formed thereon, the respective one second rope 13 is rolled on the first threaded gear 212 of the respective one first rotatable wheel 211, wherein the second rotary shaft 22 includes two second rotatable wheels 221 connected on two sides thereof, and a respective one second rotatable wheel 221 has a second threaded gear 222 formed thereon, wherein the respective one first rope 12 is rolled on the second threaded gear 222 of the respective one second rotatable wheel 221. The massager 20 includes a second motor 23 configured to drive the first rotary shaft 21 or the second rotary shaft 22 to rotate, wherein a drive wheel 24 is meshed with the respective one first rotatable wheel 211 and the respective one second rotatable wheel 221 so as to drive the respective one first rotatable wheel 211 and the respective one second rotatable wheel 221 to rotate in a same direction, hence the first threaded gear 212 of the respective one first rotatable wheel 211 is configured to roll the respective one second rope 13, and the second threaded gear 222 of the respective one second rotatable wheel 221 is configured to unroll the respective one first rope 12. Alternatively, the first threaded gear 212 of the respective one first rotatable wheel 211 is configured to unroll the respective one second rope 13, and the second threaded gear 222 of the respective one second rotatable wheel 221 is configured to roll the respective one first rope 12, such that the massager 20 moves forward and backward reciprocately along an inner wall of the frame 11, and the massager 20 includes a massage element 25 configured to massage a user sit on the base 10.

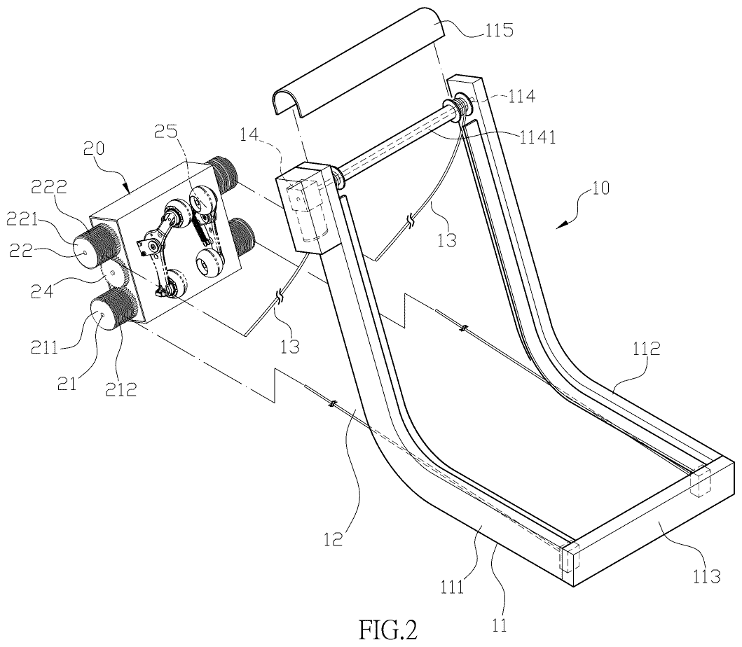

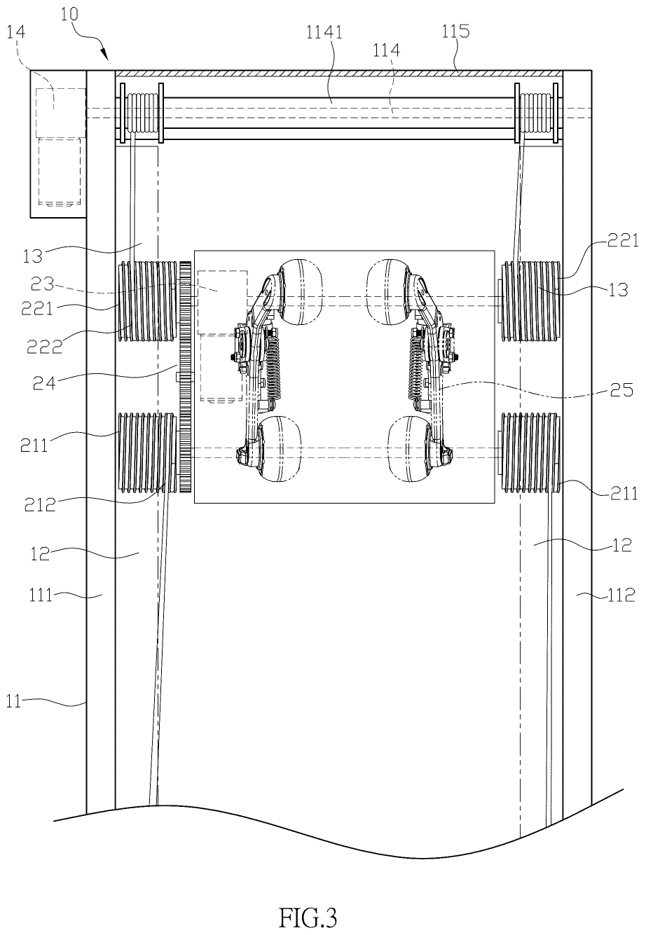

With reference to FIGS. 2-3, in another embodiment, the drive wheel 24, the respective one first rotatable wheel 211, and the respective one second rotatable wheel 221 are located on a left side of the massager 20.

In another embodiment, the drive wheel 24, the respective one first rotatable wheel 211, and the respective one second rotatable wheel 221 are located on a right side of the massager 20.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A structure of adjusting a massage contact surface strength of a massage chair comprising: a base and a massager;
wherein the base includes a frame which has a first fringe, a second fringe, a connection fringe connected with a front end of the first fringe and a front end of the second fringe, a rotary shaft rotatably connected with a rear end of the first fringe and a rear end of the second fringe, a first motor fixed on an outer wall of the frame and configured to drive the rotary shaft to rotate, wherein the rotary shaft has a rotation column, and the frame further includes a cap connected between the rear end of the first fringe and the rear end of the second fringe and configured to shield the rotation column, two first ropes connected on two sides of the connection fringe, and two second ropes connected on two sides of the rotation column, wherein the two first ropes and the two second ropes are a steel cable;
wherein the massager includes a first rotary shaft and a second rotary shaft which are rotatably connected on a front end and a rear end of the massager, wherein the first rotary shaft includes two first rotatable wheels connected on two sides thereof, and a respective one first rotatable wheel has a first threaded gear formed thereon, the respective one first rope is rolled on the first threaded gear of the respective one first rotatable wheel, wherein the second rotary shaft includes two second rotatable wheels connected on two sides thereof, a respective one second rotatable wheel has a second threaded gear formed thereon, and the respective one second rope is rolled on the second threaded gear of the respective one second rotatable wheel;
wherein the massager further includes a second motor configured to drive the first rotary shaft or the second rotary shaft to rotate, wherein a drive wheel is meshed with the respective one first rotatable wheel and the respective one second rotatable wheel so as to drive the respective one first rotatable wheel and the respective one second rotatable wheel to rotate in a same direction, hence the first threaded gear of the respective one first rotatable wheel is configured to roll the respective one first rope, and the second threaded gear of the respective one second rotatable wheel is configured to unroll the respective one second rope; alternatively, the first threaded gear of the respective one first rotatable wheel is configured to unroll the respective one first rope, and the second threaded gear of the respective one second rotatable wheel is configured to roll the respective one second rope, such that the massager moves forward and backward reciprocately along an inner wall of the frame, and the massager includes a massage element configured to massage a user sit on the base;
wherein the first motor drives the rotary shaft to rotate so that the respective one second rope is rolled on the rotation column of the rotary shaft to shorten a length of a middle section of the respective one second rope, and two ends of the massager are pulled upward so as to extend the massage element out of the base, thus massaging the user;
wherein the first motor drives the rotary shaft to rotate so that the respective one second rope is unrolled on the rotation column of the rotary shaft to lengthen the length of the middle section of the respective one second rope, and the two ends of the massager is pulled downward so as to retract the massage element in the base, thus not massaging the user.

2. A structure of adjusting a massage contact surface strength of a massage chair comprising: a base and a massager;
wherein the frame has a first fringe, a second fringe, a connection fringe connected with a rear end of the first fringe and a rear end of the second fringe, a rotary shaft rotatably connected with a front end of the first fringe and a front end of the second fringe, a first motor fixed on an outer wall of the frame and configured to drive the rotary shaft to rotate, wherein the rotary shaft has a rotation column, and the frame further includes a cap connected between the front end of the first fringe and the front end of the second fringe and configured to shield the rotation column, two first ropes connected on two sides of the connection fringe, and two second ropes connected on two sides of the rotation column, wherein the two first ropes and the two second ropes are a steel cable;
wherein the massager includes a first rotary shaft and a second rotary shaft which are rotatably connected on a front end and a rear end of the massager, wherein the first rotary shaft includes two first rotatable wheels connected on two sides thereof, and a respective one first rotatable wheel has a first threaded gear formed thereon, the respective one second rope is rolled on the first threaded gear of the respective one first rotatable wheel, wherein the second rotary shaft includes two second rotatable wheels connected on two sides thereof, and a respective one second rotatable wheel has a second threaded gear formed thereon, wherein the respective one first rope is rolled on the second threaded gear of the respective one second rotatable wheel;
wherein the massager includes a second motor configured to drive the first rotary shaft or the second rotary shaft o rotate, wherein a drive wheel is meshed with the respective one first rotatable wheel and the respective one second rotatable wheel so as to drive the respective one first rotatable wheel and the respective one second rotatable wheel to rotate in a same direction, hence the first threaded gear of the respective one first rotatable wheel is configured to roll the respective one second rope, and the second threaded gear of the respective one second rotatable wheel is configured to unroll the respective one first rope, alternatively, the first threaded gear of the respective one first rotatable wheel is configured to unroll the respective one second rope, and the second threaded gear of the respective one second rotatable wheel is configured to roll the respective one first rope, such that the massager moves forward and backward reciprocately along an inner wall of the frame, and the massager includes a massage element configured to massage a user sit on the base;
wherein the first motor drives the rotary shaft to rotate so that the respective one second rope is unrolled on the rotation column of the rotary shaft to lengthen the length of the middle section of the respective one second rope, and the two ends of the massager is pulled downward so as to retract the massage element in the base, thus not massaging the user.

3. The structure of adjusting a massage contact surface strength of a massage chair as claimed in claim 1, wherein the base and the massager are mounted in the massage chair.

4. The structure of adjusting a massage contact surface strength of a massage chair as claimed in claim 2, wherein the base and the massager are mounted in the massage chair.

5. The structure of adjusting a massage contact surface strength of a massage chair as claimed in claim 1, wherein the drive wheel, the respective one first rotatable wheel, and the respective one second rotatable wheel are located on a left side of the massager.

6. The structure of adjusting a massage contact surface strength of a massage chair as claimed in claim 2, wherein the drive wheel, the respective one first rotatable wheel, and the respective one second rotatable wheel are located on a left side of the massager.

7. The structure of adjusting a massage contact surface strength of a massage chair as claimed in claim 1, wherein the drive wheel, the respective one first rotatable wheel, and the respective one second rotatable wheel are located on a right side of the massager.

8. The structure of adjusting a massage contact surface strength of a massage chair as claimed in claim 2, wherein the drive wheel, the respective one first rotatable wheel, and the respective one second rotatable wheel are located on a right side of the massager.
